(19) United States
(12) Patent Application Publication
(10) Pub. No.: US 2023/0093992 A1
(43) Pub. Date: Mar. 30, 2023

(54) Secure Communication in a Computing System

(71) Applicant: Apple Inc., Cupertino, CA (US)

(72) Inventors: Birju N. Shah, Redwood City, CA (US); James E. Zmuda, Redwood City, CA (US); Jangwon Lee, San Jose, CA (US)

(21) Appl. No.: 17/934,642

(22) Filed: Sep. 23, 2022

Related U.S. Application Data
(60) Provisional application No. 63/247,975, filed on Sep. 24, 2021.

(51) Int. Cl. H04L 9/32; H04L 9/30

(52) U.S. Cl. CPC H04L 9/3247; H04L 9/30

(57) ABSTRACT

Securely communicating traffic between control units interconnected by a network. An electronic control unit (ECU) receives a signed manifest identifying public keys for a group of ECUs authorized to communicate over the network. The ECU performs an authentication exchange with the ECUs in the group. The authentication exchange uses public keys identified in the manifest. Based on the authentication exchange, the ECU distributes a group key to authenticated ones of the ECUs that communicate messages authenticated using the group key.

The present application claims priority to U.S. Prov. Appl. No. 63/247,975, filed Sep. 24, 2021, which is incorporated by reference herein in its entirety.

### TECHNICAL FIELD

This disclosure relates generally to network security and, more specifically, to authenticating components of a computing system.

### BACKGROUND

Network security is a frequent concern when designing a computer network. This can hold true for large enterprise networks as well as smaller networks such as a local area network where individual units may lack adequate levels of security and have relatively few restrictions placed on how they communicate with each other. For example, modern vehicles may rely on a decentralized computing system that includes specialized control units interconnected through an internal vehicle network. As traditional vehicle networks may lack security protections, individual control units may be hacked by nefarious actors. For example, the nefarious actors may tamper with the operation of a hacked control unit and also send malicious commands to other interconnected control units, which may result in unpredictable or unsafe operation of the vehicle.

### BRIEF DESCRIPTION OF THE DRAWINGS

FIG. 1 is a block diagram illustrating an example of a secure network with multiple interconnected components that communicate authenticated messages between one another according to some embodiments.

FIG. 2 is a block diagram illustrating an example of provisioning and generation of a manifest used to authenticate legitimate components of the network and facilitate key distribution according to some embodiments.

FIG. 3 is a block diagram illustrating an example of implementing a mutual authentication between various components according to some embodiments.

FIG. 4 is a block diagram illustrating an example of implementing a scheme for distributing group keys among the members of defined communication groups according to some embodiments.

FIG. 5 is a block diagram illustrating an example of the flow of network traffic between the components of the network using authenticated messages according to some embodiments.

FIG. 6 is a flow diagram illustrating an exemplary method that implements an authentication scheme to enable secure communication between various components of the network according to some embodiments.

FIG. 7 is a block diagram illustrating an exemplary computer system that may be used to implement one or more components of the network according to some embodiments.

### DETAILED DESCRIPTION

A communication system within an apparatus (e.g., an appliance, machine, robot, industrial system, medical system, vehicle etc.) may become threatened or compromised due to any of various factors. For example, an illicit repair operation may be performed in which an electronic control unit (ECU) of the apparatus is replaced by an unknown or unauthorized ECU, which may not function correctly or as reliably. As another example, malicious commands may be sent to gain control over the apparatus, by hacking an ECU (e.g., through port or interface). Alternatively, an ECU with a wireless network interface (e.g., an entertainment unit of a vehicle) may be remotely compromised and caused to issue malicious commands to other ECUs of the apparatus. In cases where the potential to lose control over operation of the apparatus is a significant concern, the security of the communication between the ECUs can be important.

The present disclosure describes various techniques for enhancing security in a computing system through a multi-phase authentication scheme. As will be discussed below, this scheme may seek to bind legitimate ECUs to a particular apparatus, by using a signed manifest to enable authenticated communications between the ECUs of the apparatus. In various embodiments, a leader ECU may receive the signed manifest identifying public keys for a group of ECUs authorized to communicate with one another. This manifest may be provided, for example, by a manufacturer or another trusted entity. At the start of an operation session (e.g., vehicle driving session, machine operation session, etc.), the leader ECU may use the public keys identified in the manifest to perform an authentication exchange with the ECUs in the group. In response to successfully authenticating the ECUs in the group, the leader ECU may distribute a group key to the ECUs in order to enable them to communicate messages authenticated using the group key. For example, in some embodiments discussed below, an ECU may use the group key to generate a message authentication code (MAC) that is appended to a message before being sent to another ECU, which may use the MAC to verify the integrity of the message and confirm that the message came from another group member. In many instances, authenticating ECUs in this manner may prevent the installation of substandard, non-OEM ECUs as well as restrict a compromised ECU's ability to communicate with other non-group members.

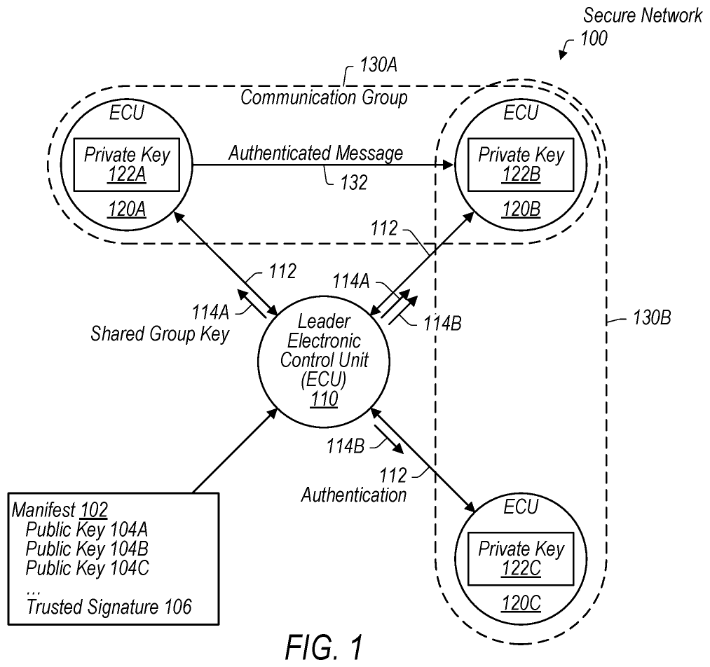

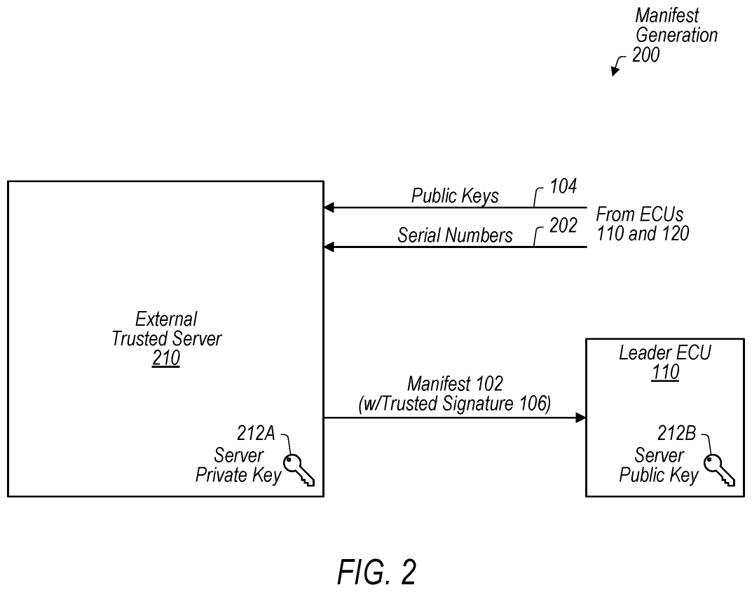

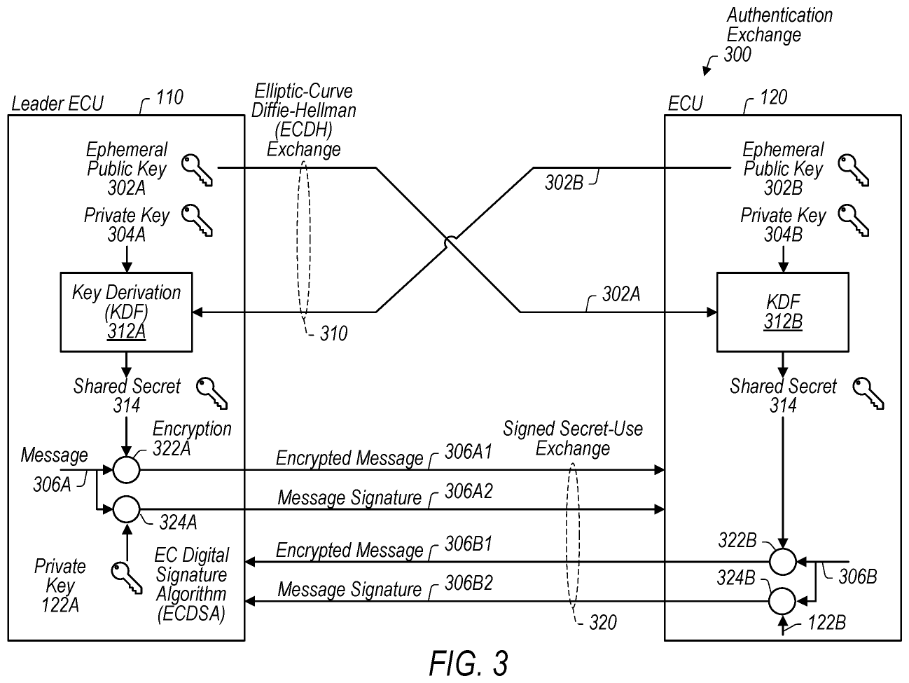

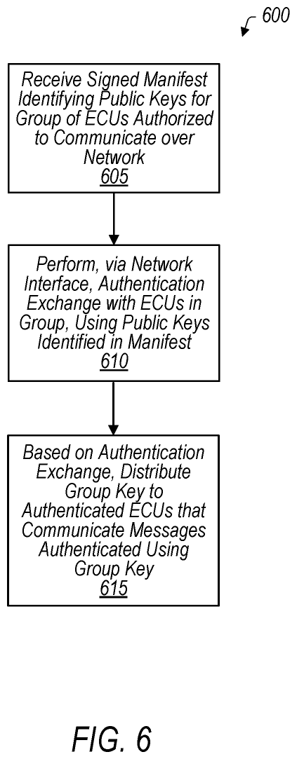

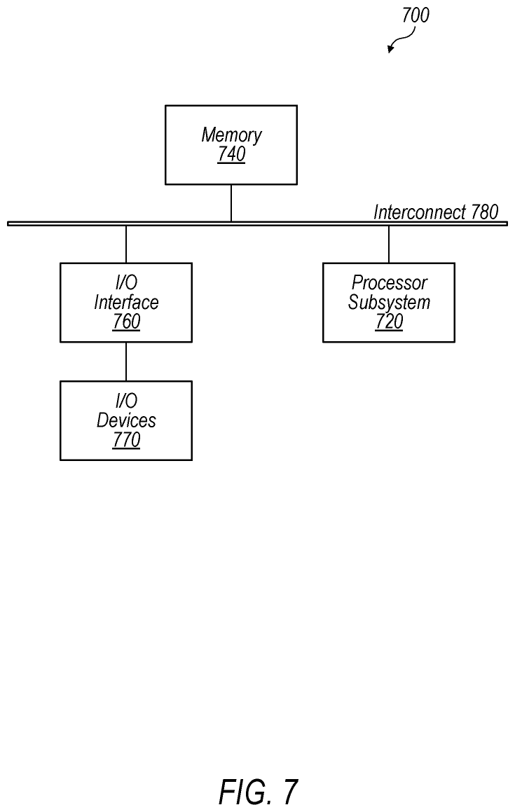

The present disclosure begins with a description of components of a secure network with respect to FIG. 1. The provisioning and generation of a manifest that provides a list of the legitimate components of the network is described in FIG. 2. The three phases of a multi-step authentication scheme of the present disclosure are described with respect to FIGS. 3-5. An exemplary method implementing the authentication scheme of the present disclosure is described in FIG. 6. Lastly, an exemplary computer system that may be used to implement one or more components of the network is discussed with FIG. 7.

Turning now to FIG. 1, a block diagram of a secure network 100 is depicted. In the illustrated embodiment, network 100 includes multiple ECUs including a leader ECU 110 that is coupled to multiple other ECUs 120A-C. In the illustrated embodiment, ECUs 120A-C are shown to include private keys 122A-C, respectively. FIG. 1 also depicts a manifest 102 accessible to leader ECU 110. In various embodiments, manifest 102 includes public keys 104A-C that correspond to private keys 122A-C of ECUs 120A-C as well as the public key of leader ECU 110. Manifest 102 also includes a trusted signature 106. In various embodiments, network 100 may be implemented differently than shown. Accordingly, in some embodiments, more (or less) ECUs 120 may be present, the leader ECU 110 may be part of one or more communication groups 130, any of the ECUs 120 may be designated as a leader ECU, all ECUs 120 or a subset of ECUs 120 may have access to manifest 102 (in addition to leader ECU 110 having access to manifest 102), etc. In some embodiments, leader ECU 110 may be the only ECU with manifest 102, but follower ECUs 120 may be provisioned with the leader ECUs 110's public key (and potentially other information about the leader ECU such as its serial number), which may be signed into the manifest 102. Although groups 130A and 130B are depicted as including only two ECUs 120, in some embodiments, groups 130 may include more than two ECUs 120 and 110, which may be the case, for example, when multicasting is used to communicate traffic between group members.

Secure network 100, in some embodiments, is a local area network (LAN) configured to facilitate the communication of network traffic among ECUs 110 and 120 in a secure manner. In some embodiments, secure network 100 is included in an apparatus (e.g., electronic device, appliance, machine, robot, industrial system, medical system, vehicle etc.).; however, in other embodiments, network 100 may be located elsewhere. In some embodiments, ECUs 120 communicate network traffic in Ethernet frames in accordance with IEEE 802.3; however, in other embodiments, other networking protocols may be supported such as control area network (CAN). In some embodiments, network 100 may include components other than ECUs. For example, network 100 may include a gateway device to facilitate the coupling of ECUs to an external server, an external network (e.g., the Internet), etc.

As used herein, the term “electronic control unit (ECU)” is to be interpreted according to its understood meaning in the art, and includes an embedded system (e.g., microcontroller). Examples for ECUs 110 and 120A-C may include a motor ECU that communicates torque-control messages and wheel-speed messages in order to control operation of a motor, a brake-system ECU that communicates brake control messages in order to apply braking, a backup camera ECU that communicates video, a steering ECU that communicates steering-wheel-angle messages to control turning, etc. In some instances, ECUs may be manufactured by third parties and installed into an apparatus by a manufacturer as OEM components as the apparatus is being built. As time progresses, ECUs may need to be replaced due to particular apparatus repairs, which may be handled by someone other than the manufacturer. As noted above, an apparatus's security may also adversely be impacted when non-OEM components are used or when repairs are performed in an unauthorized manner.

An apparatus may also not always implement adequate levels of security in some instances. When ECUs are functioning normally, however, their communication may be deterministic/predictable. For example, an ECU associated with a backup camera may normally communicate with a navigation ECU in order to present video from a backup camera to a driver. In contrast, the navigation ECU should likely not be issuing commands to the brake control ECU to apply the brakes. In the example depicted in FIG. 1, groups 130A and 130B represent ECUs that are supposed to communicate with one another during normal operation. Accordingly, ECU 120A may normally communicate with ECU 120B but may not normally communicate with ECU 120C in this example. As will be discussed in greater detail below, in various embodiments, ECUs 110 and 120 perform an authentication scheme used to recognize ECUs that are authorized to be part of network 100 and restrict their communications to only those authorized ECUs belonging to the same group (or groups) 130.

In various embodiments, this authentication scheme uses information in manifest 102 as the basis for identifying legitimate (or authorized) ECUs belonging to the apparatus. As shown, manifest 102 includes public keys 104A-C belonging to ECUs 120A-C as they may correspond private keys 122A-C(i.e., public keys 104 and private keys 122 belong to the same public key pairs). As will be described in greater detail below with FIG. 2, each ECU 120 may generate a respective public key pair and provide the public key 104 of the pair for inclusion in manifest 102 while maintaining the private key 122 of the pair internally. A trusted entity, such as a manufacturer, may collect these pubic keys 104 and include them in manifest 102, which is signed with a trusted signature 106 of the trusted entity. This signed manifest 102 may then serve as the basis for establishing trust in the authentication scheme.

In the illustrated embodiment, manifest 102 is accessible to leader ECU 110 but may also be accessible, in some embodiments, to ECUs 120. In various embodiments, leader ECU 110 is tasked with coordinating performance of the authentication scheme. In some embodiments, the leader ECU may be predetermined—e.g., the ECU with the greatest compute ability may be selected as leader ECU 110. In other embodiments, leader ECU 110 may be an elected one of ECUs 120 as determined through an election at the start of the authentication scheme. Although ECU 110 is shown in FIG. 1 as being external to groups 130, ECU 110 may also belong to one or more communication groups 130. Although a single leader ECU 110 is depicted in FIG. 1, in some embodiments, ECU 110 may also be one of multiple leader ECUs each performing the authentication for a respective one or more groups of ECUs 120. In one such embodiment, secure network 100 may include multiple ECU clusters where each cluster includes a respective leader ECU 110 and one or more follower ECUs 120, which may exist in more than one cluster. For example, network 100 might include two clusters of 1) ECUs A, B, & C and 2) C, D, & E. As ECU C, in this example, is common to both clusters, ECU C, in some embodiments, could be a leader ECU 110 for both clusters, a leader ECU 110 for one cluster and a follower ECU 120 for another cluster, or a follower ECU 120 for both clusters.

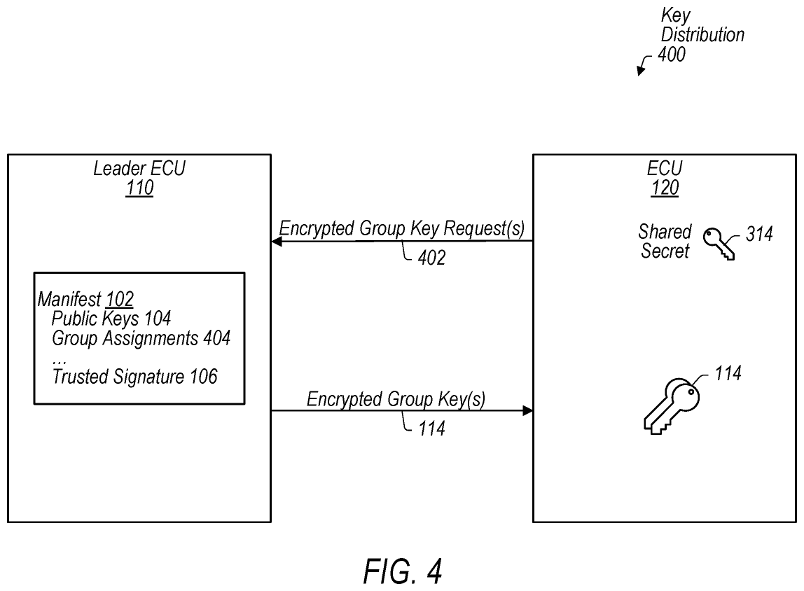

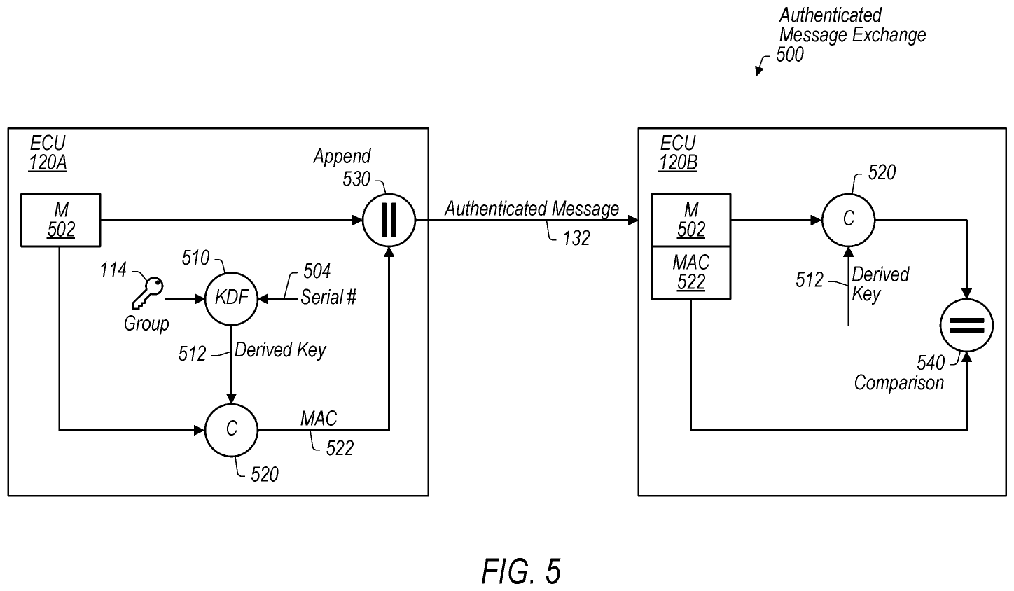

As will be discussed in greater with subsequent FIGS. 3-5, in some embodiments, the authentication scheme described herein may include three phases. In a first phase of the authentication scheme discussed with FIG. 3, leader ECU 110 performs a mutual authentication 112 with each member ECU 120A-C listed in manifest 102. As part of performing this authentication 112, a respective secret shared key may be established between the leader ECU 110 and each of the member ECUs 120A-C. In a second phase of the authentication scheme discussed with FIG. 4, leader ECU 110 generates and then distributes shared group keys 114A-B for each of the communication groups 130A-B by using the shared keys generated previously. In a third phase of the authentication scheme discussed with FIG. 5, ECUs 120 within a communication group 130 use that group's key 114 to communicate authenticated messages 132 with one another. For example, as shown in FIG. 1, ECU 120A may communicate a message 132 authenticated using group key 114A to ECU 120B, which belongs to the same communication group 130A. In various embodiments, however, leader ECU 110 does not distribute groups keys 114 to ECUs 120 that are not members of those groups 130. For example, as shown in FIG. 1, ECU 120A did not receive group key 114B from leader 110 as ECU 120A is not a member of group 130B. By not doing so, leader 110 may prevent ECU 120A from communicating messages authenticated with group key 114B to ECU 120C, which, in some embodiment, may be configured to reject messages that cannot be properly authenticated.

Restricting ECUs 120 to communicating within defined communication groups 130 can greatly improve the overall security of network 100. For example, if an illegitimate ECU is inserted into network 100, that ECU may not possess a private key 122 corresponding to one of public keys 104 in manifest 102. As a result, that ECU may be unable to perform an authentication 112 in order to receive any group keys 114 for communicating authenticated messages 132. Thus, the illegitimate ECU may be prevented from communicating with other legitimate ECUs 120. Also, because ECUs 120 are restricted to communicating within their own groups 130 in various embodiments, a compromised ECU cannot start communicating with ECUs 120 that are not members of that ECU's groups 130 as it lacks the groups keys 114 to do so. Accordingly, if ECU 120A in the example depicted in FIG. 1 becomes compromised and attempts to communicate with ECU 120C, ECU 120C may not respond to these communications as ECU 120A lacks group key 114B. The origins of manifest 102 and how it is provided to leader ECU 110 will now be discussed in greater detail with reference to FIG. 2.

Turning now to FIG. 2, a block diagram of a manifest generation 200 for obtaining a manifest 102 is depicted. In the illustrated embodiment, generation 200 includes an exchange between an external trusted server 210 and ECUs 110 and 120. In some embodiments, generation 200 may be implemented differently than shown.

In various embodiments, external trusted server 210 is a computing system that is external to the apparatus (that includes the network) but receives information relating to ECUs 110 and 120 in order to generate manifest 102. In some embodiments, external trusted server 210 is operated by the manufacturer of the apparatus, and thus, is believed to have some indicia of trust. In some embodiments, external trusted server 210 may be collocated with the apparatus during the manufacturing of the apparatus and may be accessed via a LAN interface. In other embodiments, external trusted server 210 may be accessed via a wide area network (WAN) interface (e.g., over the Internet) by ECUs 110 and 120.

In various embodiments, generation 200 may begin with ECUs 110 and 120 generating public key pairs including private keys 122 and public keys 104. ECUs 110 and 120 may then provide external trusted server 210 with their public keys 104. In some embodiments, these provided public keys 104 may be included within respective certificates, which may be self-signed or signed by a separate, trusted certificate authority. ECUs 110 and 120 may also provide other identifying information such as their serial numbers 202 (as shown), an instance ID of a system or product (e.g., a vehicle ID), etc. in order to bind them to the particular system or product. In some embodiments, this exchange may be performed when the ECUs are plugged into the apparatus (e.g., coupled to a physical interface of the apparatus) during manufacturing of the apparatus. External trusted server 210 may then create a file shown as manifest 102 that is provisioned with this received information about ECUs 110 and 120 in order to serve as a repository for this information. In order to preserve the integrity of this information, external trusted server 210 may sign the contents of manifest 102 with a server private key 212A to produce a trusted signature 106, which gets included in manifest 102. In some embodiments, external trusted server 210 may provide manifest 102 to leader ECU 110 for use during subsequent authentications of ECUs. Leader ECU 110 may also be provisioned with server 210's corresponding public key 212B in order to verify manifest 102 against trusted signature 106 prior to using any contents of manifest 102. Upon receiving manifest 102, leader ECU 110 may store the contents of manifest 102 in a non-volatile memory for persistent storage. Although not depicted, in some embodiments, manifest 102 may be provided to other ECUs 120.

In some embodiments, external trusted server 210 may generate manifests 102 after manufacture as well. For example, an authorized repairer of the apparatus may replace ECUs 110 and/or 120 during repair of the apparatus. As part of this repair, newly added ECUs may provide public keys 104 and serial numbers 202 to external trusted server 210. In some embodiments, external trusted server 210 may generate a new manifest 102 every time provisioned information about an ECU is added or removed during repair, so that manifest 102 accurately reflects current information about legitimate ECUs of network 100. To facilitate obtaining a new manifest 102, an authorized repairer or servicer may need to connect external trusted server 210 to one or more ECUs, so that ECUs 110 and 120 can communicate with server 210.

In various embodiments, the information in manifest 102 provides the foundation for secure communication between ECUs as explained by the techniques described next with FIGS. 3-5.

Turning now to FIG. 3, an authentication exchange 300 for implementing an authentication 112 is depicted. In various embodiments, authentication exchange 300 is the first phase of the authentication scheme discussed above to establish a mutual authentication between leader ECU 110 and each one of ECUs 120A-C. As shown, exchange 300 may include an initial Elliptic-Curve Diffie-Hellman (ECDH) exchange 310 followed by signed secret-use exchange 320. In other embodiments, exchange 300 may be implemented differently than shown.

In various embodiments, ECDH exchange 310 is performed to establish a shared secret 314 between leader ECU 110 and each of ECUs 120A-C. As shown, exchange 310 may begin with leader ECU 110 generating an ephemeral public key pair including public key 302A and private key 304A and ECU 120 generating an ephemeral public key pair including public key 302B and private key 304B. ECU 120 may provide its ephemeral public key 302B to ECU 110 while ECU 110 provides its ephemeral public key 302B to ECU 120. Leader ECU 110 may then perform a key derivation function (KDF) 312A using ECU 120's ephemeral public key 302B and its ephemeral private key 304A to produce a shared secret 314. ECU 120 may also perform a KDF 312B using ECU 110's ephemeral public key 302A and its ephemeral private key 304B to produce the same shared secret 314. While KDFs 312 may be implemented in any suitable manner, in the illustrated embodiment, KDFs 312A and 312B may be implemented using ECDH. In some embodiments, KDFs 312 may receive additional inputs, such as a salt, padding, etc. in order to increase the entropy used to generate secrets 314.

In order to mutually authenticate one another, a two-way signed secret-use exchange 320 is performed using established shared secret 314, private keys 122, and public keys 104 identified in manifest 102 to prove identities of ECU 110 and 120 to one another. In the illustrated embodiment, signed secret-use exchange 320 includes ECU 110 generating message 306A and encrypting message 306A with shared secret 314 using encryption operation 322A to generate encrypted message 306A1, which may be implemented using Advanced Encryption Standard (AES). ECU 110 may also sign message 306A using its private key 122A (corresponding to its public key 104 in manifest 102) to generate a message signature 306A2, which may be performed using of Elliptic-Curve Digital Signature Algorithm (ECDSA) 324A in some embodiments. ECU 110 then sends both encrypted message 306A1 and message signature 306A2 to ECU 120. ECU 120 similarly may generate a message 306B and encrypt message 306B with shared secret 314 using an encryption operation 322B to generate encrypted message 306B1, which may also be implemented using AES. ECU 120 also may sign message 306B using its private key 122B (corresponding to its public key 104 in manifest 102) to generate message signature 306B2 using ECDSA 324B. ECU 120 may then send both encrypted message 306B1 and message signature 306B2 to ECU 110. Lastly, ECUs 110 and 120 may decrypt message 306A1 and 306B1 and verify signatures 306A2 and 306B2 using the public keys 104 corresponding private keys 122A and 122B as a successful decryption and verification by both ECUs 110 and 120 demonstrates trustworthiness because both sides have proven knowledge of the previously established shared secret 314 and the ability to generate valid signatures tied to public keys 104 in manifest 102.

At the conclusion of signed secret-use exchange 320, both ECUs 110 and 120 recognize each other as valid ECUs and have established a shared secret 314 for distributing group keys as discussed next with respect to FIG. 4.

Turning now to FIG. 4, an example of group key distribution 400 is depicted. Key distribution 400 is an exchange in which leader ECU 110 distributes group keys 114 to member ECUs (e.g., ECUs 120) to facilitate secure communication among member ECUs. As mentioned, key distribution 400 may implement the second phase of the authentication scheme described in the present disclosure.

As shown in FIG. 4, key distribution 400 may begin when a member ECU 120 sends an encrypted group key request 402 to leader ECU 110. In various embodiments, the contents of encrypted group key request 402 may be encrypted by shared secret 314 for enhanced security. In various embodiments, this request 402 may be sent as an ECU 120 (or more generally the apparatus) is being powered on and in conjunction with the start of a new operation session (e.g., vehicle drive session). In some embodiments, the start of a new operation session may occur responsive to an operator (e.g., driver) opening a door of the apparatus, an operator presenting a physical key to the apparatus, pressing a start button of the apparatus, etc. In some embodiments, member ECU 120 may also send encrypted group key request 402 to leader ECU 110 more frequently (or less frequently) such as periodically within a given drive session (e.g., after expiration of a configurable amount of time) in order refresh keys 114. In some embodiments, member ECU 120 sends a single encrypted group key request 402 to leader ECU 110 in which it includes its own serial number (e.g., serial number 202 of ECU 120) to facilitating determining its relevant groups 130. In other embodiments, member ECU 120 may include other information in an encrypted group key request 402 such as identifying all communication groups that an ECU 120 belongs to.

Upon receiving encrypted group key request 402, leader ECU 110 may identify all the communication groups 130 for ECU 120 by looking up the serial number 202 in a set of group assignments 404. In the illustrated embodiment, group assignments 404 are shown as being included in manifest 102. In some other embodiments, however, group assignments 404 may be contained in another signed data structures (e.g., signed by server 210), may encoded into the program instructions executed by ECUs 110 and/or 120 (e.g., which may also be signed server 210), etc. In some embodiments, group assignments 404 may be determined at compile time for program instructions being executed by ECUs 110 and 120, during configuration package delivery such as in a software update, during fabrication of secure network 100, etc. After identifying each communication group that member ECU 120 belongs to, leader ECU 110 may generate a respective group key for each communication group 130 (e.g., using a random number generator) or determine whether it as already generated such a key responsive to an earlier request 402. Leader ECU 110 may then encrypt the relevant group keys 114 with the shared secret 314 established previously with the ECU 120 and distribute them to ECU 120. Since a shared secret 314, in some embodiments, is unique to a particular ECU 120, only the particular ECU 120 may be able to decrypt its encrypted group keys 114 for each of its communication group 130. Thus, an unauthorized ECU, for example, that has not been properly authenticated and is not in possession of shared secret 314 may be unable to decrypt any encrypted group keys 114, and hence, cannot take part in communications with other ECUs of a communication group 130 as will be discussed next with respect to FIG. 5 below.

Turning now to FIG. 5, a block diagram of an authenticated message exchange 500 is depicted. As will be discussed, authenticated message exchange 500 may implement the third phase of the authentication scheme in which a sending ECU 120A uses a group key 114 to attest to the authenticity of a message 132 and a receiving ECU 120B uses the group key 114 to confirm this authenticity as well as the message 132's integrity. In the illustrated embodiment, exchange 500 uses keyed message authentication codes (MACs); however, in other embodiments, other techniques may be used such as digital signatures, verifiable random functions (VRFs), encryption, etc.

In some embodiments, prior to performance of an exchange 500, an ECU 120A may entangle its group key 114 (or keys 114) with information that uniquely identifies ECU 120A in order to attest that it is the source of particular messages 132. In the illustrated embodiment, ECU 120A implements this by performing a key derivation function (KDF) 510 using a received group key 114 and its serial number 504 to produce a derived key 512. In some embodiments, performing KDF 510 may include using its serial number 504 to encrypt its group key 114 via an AES operation or another encryption algorithm. In some embodiments, group key 114 may be entangled with other information (e.g., a randomly generated nonce)—or used without any entanglement.

In various embodiments, exchange 500 may begin with ECU 120A generating a message M 502 that it wants to send to ECU 120B and determining the relevant group 130 that includes ECU 120B. ECU 120A may then select the corresponding derived key 512 for that group 130 and perform a cryptographic operation C 520 on the message 502 using the selected key 512. In the illustrated embodiment, this cryptographic operation C 520 produces MAC 522, which ECU 120A then attaches to message 502 via an append operation 530 to produce an authenticated message 132. ECU 120A may then transmit this authenticated message 132 to ECU 120B.

On the receiver side, ECU 120B may also produce derived keys 512 in a similar manner using KDF 510 for the other ECUs 120 in its groups 130. In some embodiments, ECU 120B may access manifest 102 to identify relevant serial numbers the ECUs including ECU 120A. When ECU 120B then receives an authenticated message 132, ECU 120B may initially review the message contents in order to identify the purported source and determine the revenant derived key 512 for the group 130 associated with the purported source. In the illustrated embodiment, ECU 120B then verifies the appended MAC 522 by generating a local copy of the MAC via performance of cryptographic operation C 520 with the relevant key 512 and performing a comparison 540 of the locally generated MAC with the appended MAC 522. If comparison 540 results in a match, ECU 120B may determine that message 132 has been properly authenticated (and its integrity preserved) as the sending ECU 120A has successfully demonstrated knowledge of the group key 114 and, in some embodiments, its serial number 504. If, however, comparison 540 fails due to a mismatch (or an inability to identify the relevant key 512), ECU 120B may discard the message 132 as being invalid. Such an outcome may occur, for example, if message 132 was tampered with after transmission, if an ECU 120 tried to communicate to nonmembers of its groups 130, or if an ECU 120 was never identified in manifest 102 in the first place.

Turning now to FIG. 6, a flow diagram of a method 600 for communicating messages over a network is depicted. Method 600 is one embodiment of a method that may be performed by an ECU in the apparatus such as leader ECU 110. In some instances, performance of method 600 may allow for more secure communication between ECUs. In some embodiments, steps 605-615 may be performed in parallel or in a different order than shown.

In step 605, an ECU (e.g., Leader ECU) receives a signed manifest (e.g., manifest 102) identifying public keys (e.g., public keys 104A-C) for a group of ECUs (e.g., ECUs 120A-C) authorized to communicate over a network (e.g., secure network 100). In some embodiments, the manifest includes a plurality of certificates for the public keys, identifies (e.g., via group assignments 404) serial numbers (e.g., serial numbers 504) of the ECUs belonging to the group, and is signed (e.g., via trusted signature 106) by a manufacturer of an apparatus including the ECU. In some embodiments, the network is a controller area network (CAN) bus. In some embodiments, the ECU includes a public key of the manufacturer. In some embodiments, the ECU verifies the manifest using the public key of the manufacturer, prior to using any contents of manifest 102. In some embodiments, in response to verifying the manifest, the ECU stores the contents of the manifest in a non-volatile memory for persistent storage. In some embodiments, if the ECU cannot verify the manifest using the public key of the manufacturer, the ECU prevents use of the manifest (e.g., restricting access to the manifest, foregoing storage of the manifest, deleting the manifest, etc.). In some embodiments, the ECU receives the signed manifest in response to a startup of the apparatus. In some embodiments, the ECU receives the signed manifest in response to an apparatus repair operation. In some embodiments, the ECU receives the signed manifest in response to a request for the manifest provided by the apparatus to an external system (e.g., a server of the manufacturer). In some embodiments, the ECU provides the request for the manifest in response to detection of a new ECU within the apparatus. In some embodiments, the ECU provides the request for the manifest in response to a check for updates. In some embodiments, the ECU provides the request for the manifest in response to a communication operation for communication among ECUs within the apparatus. In some embodiments, the ECU provides the request for the manifest in response to a determination that the ECU does not have access to a valid manifest (e.g., the ECU does not include any manifest, the ECU does not include any valid manifest, etc.). However, the ECU can receive the signed apparatus in response to any suitable trigger or event. In some embodiments, if the verification of the manifest fails, the ECU may discontinue performance of method 600 such as not performing steps 610 and 615. In some embodiments, if method 600 is being performed in conjunction with a startup of the apparatus, the ECU may discontinue the startup (and provide an error message).

In step 610, the ECU (e.g., leader ECU 110) performs, via a network interface, an authentication exchange (e.g., authentication exchange 300) with ECUs in a group (e.g., group 130), using the public keys identified in the manifest. In some embodiments, the authentication exchange includes establishing a shared key (e.g., secret 314) with another ECU in the group and verifying a signature (e.g., signature 302B2) received from the other ECU and signed using a private key corresponding to a public key identified in the manifest for the other ECU.

In step 615, the ECU, based on the authentication exchange, distributes (e.g., via key distribution 400) a group key (e.g., group key 114) to authenticated ECUs that communicate messages authenticated using the group key. In some embodiments, the distributing includes receiving, from the other ECU, a request (e.g., request 402) for one or more group keys associated with one or more groups that include the other ECU as a member and providing the requested one or more group keys encrypted using the established shared key. In some embodiments, the distributing includes, prior to providing the requested one or more group keys, confirming that the manifest identifies (e.g., group assignments 404) the other ECU. In various embodiments, the ECU is configured to perform the authentication exchange and the distributing for each operation session of the apparatus (e.g., drive session of a vehicle) including the ECU.

In some embodiments, the ECU is a member of the group (e.g., leader 110 is also in a group 130). In such an embodiment, method 600 further includes storing the group key in a memory of the ECU, receiving, from another ECU in the group, a message (e.g., an authenticated message 132) authenticated using the distributed group key and validating the message using the stored group key. In some embodiments, the validating includes using the stored group key to generate a message authenticate code (MAC) from the message and comparing (e.g., via comparison 540) the generated MAC with a MAC (e.g., MAC 522) included in the message by the other ECU. In some embodiments, the message is authenticated using a cryptographic key (e.g., derived key 512) that entangles the group key with a serial number (e.g., serial number 504) unique to the other ECU, and the validating includes deriving the cryptographic key by using the group key to apply a key derivation function (e.g., KDF 510) to the serial number

Exemplary Computer System

Turning now to FIG. 7, a block diagram of an exemplary computer system 700 is depicted. Computer system 700 is one embodiment of a computer system that may be used to implement one or more components of secure network 100. In the illustrated embodiment, computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, network computer, an embedded system, etc. Although a single computer system 700 is shown in FIG. 7 for convenience, system 700 may also be implemented as two or more computer systems operating together.

Processor subsystem 720 may include one or more processors or processing units configured to execute program instructions to perform functionality described herein. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is a non-transitory computer readable medium usable store program instructions executable by processor subsystem 720 to cause system 700 perform various operations described herein. For example, memory 740 may store program instructions to implement the functionality associated with ECU 110, ECU 120A, ECU 120B, or ECU 120C. System memory 740 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 700 is not limited to primary storage such as memory 740. Rather, computer system 700 may also include other forms of storage such as cache memory in processor subsystem 720 and secondary storage on I/O Devices 770 (e.g., a hard drive, storage array, etc.). In some embodiments, these other forms of storage may also store program instructions executable by processor subsystem 720 to perform operations described herein.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 770 (e.g., configured to communicate over Wi-Fi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a plurality of electronic control units (ECUs);
wherein a first of the plurality of ECUs is configured to:
access a signed manifest that includes public keys corresponding to the plurality of ECUs, wherein the signed manifest includes a trusted signature of a manufacturer of the apparatus;
verify the trusted signature using a public key of the manufacturer;
use the public keys to perform an authentication of the plurality of ECUs; and
based on the authentication, distribute a group key to a subset of the plurality of ECUs belonging to a group.

2. The apparatus of claim 1, wherein the first ECU is configured to use the public keys to perform the authentication of the plurality of ECUs and distribute the group key to the subset of the plurality of ECUs belonging to the group, in response to initiation of an operation session of the apparatus.

3. The apparatus of claim 1, wherein the first ECU is configured to use the public keys to perform an authentication of the plurality of ECUs in response to verification of the trusted signature.

4. The apparatus of claim 1,
wherein verifying the trusted signature using a public key of the manufacturer comprises: storing the public keys included in the manifest, in response to verification of the trusted signature, and
wherein using the public keys to perform the authentication of the plurality of ECUs comprises: accessing the stored public keys.

5. The apparatus of claim 1,
wherein a second ECU of the group is configured to:
communicate, to a third ECU of the group, messages authenticated using the distributed group key.

6. The apparatus of claim 5, wherein the authentication includes the first ECU performing an elliptic curve Diffie-Hellman exchange to establish a shared key with the second ECU.

7. The apparatus of claim 6, wherein distributing the group key to the second ECU includes encrypting the group key using the shared key.

8. The apparatus of claim 7, wherein the second ECU is configured to:
derive a key by using the group key to apply a key derivation function to a serial number unique to the second ECU; and
perform a cryptographic operation on the message using the derived key to authenticate the message to the third ECU.

9. The apparatus of claim 1, wherein the apparatus is a vehicle, wherein the plurality of ECUs is coupled together via a controller area network (CAN) bus, and wherein the manifest identifies the subset of ECUs as belonging to the apparatus.

10. The apparatus of claim 1, wherein the first of the plurality of ECUs is configured to:
access a second signed manifest that includes public keys corresponding to a second plurality of ECUs, wherein the second signed manifest includes a second trusted signature of the manufacturer of the apparatus;
verify the second trusted signature using the public key of the manufacturer;
use the public keys included in the second signed manifest to perform an authentication of the second plurality of ECUs; and
based on the authentication, distribute a second group key to a subset of the second plurality of ECUs.

11. A method, comprising:
accessing, by a first of a plurality of electronic control units (ECUs) in an apparatus, a signed manifest that includes public keys corresponding to the plurality of ECUs, wherein the signed manifest includes a trusted signature of a manufacturer of the apparatus;
verifying, by the first ECU, the trusted signature using a public key of the manufacturer;
using, by the first ECU, the public keys to perform an authentication of the plurality of ECUs; and
based on the authentication, the first ECU distributing a group key to a subset of the plurality of ECUs in the apparatus that belong to a group, wherein the plurality of ECUs is coupled together via a controller area network (CAN) bus, and wherein the manifest identifies the subset of ECUs as belonging to the apparatus.

12. The method of claim 11, further comprising:
communicating, by a second ECU of the group to a third ECU of the group, messages authenticated using the distributed group key.

13. The method of claim 12, using the distributed group key comprises:
using the distributed group key to generate a message authenticate code (MAC) from the message; and
comparing the generated MAC with a MAC included in the message.

14. The method of claim 11, wherein the using and the distributing are in response to initiation of an operation session of the apparatus.

15. The method of claim 11, wherein the authentication comprises:
establishing a shared key with another ECU in the group; and
verifying a signature received from the other ECU and signed using a private key corresponding to a public key included in the manifest for the other ECU.

16. The method of claim 15, the distributing comprises:
receiving, from the other ECU, a request for one or more group keys associated with one or more groups that include the other ECU as a member; and
providing the requested one or more group keys, wherein the provided one or more group keys are encrypted using the established shared key.

17. The method of claim 11, wherein the apparatus is a vehicle.

18. A non-transitory computer readable medium having program instructions stored therein that are executable by a first of a plurality of electronic control units (ECUs) in an apparatus to cause the first ECU to perform operations comprising:
accessing a signed manifest that includes public keys corresponding to the plurality of ECUs, wherein the signed manifest includes a trusted signature of a manufacturer of the apparatus;
verifying the trusted signature using a public key of the manufacturer;
using the public keys to perform an authentication of the plurality of ECUs; and
based on the authentication, distributing a group key to a subset of the plurality of ECUs in the apparatus that belong to a group,
wherein the plurality of ECUs is coupled together via a controller area network (CAN) bus, and
wherein the manifest identifies the subset of ECUs as belonging to the apparatus.

19. The computer readable medium of claim 18, wherein the operations further comprise:
communicating, to another ECU of the group, messages authenticated using the distributed group key.

20. The computer readable medium of claim 18, wherein the operations further comprise:
establishing a shared key with another ECU in the group; and
using the shared key to encrypt the grouped key distributed to the other ECU.
